(19) United States
(12) Patent Application Publication
(10) Pub. No.: US 2024/0004169 A1
(43) Pub. Date: Jan. 4, 2024

(54) Wide-Angle Lens Assembly

(71) Applicants: Sintai Optical (Shenzhen) Co., Ltd., ShenZhen City (CN); Asia Optical Co., Inc., Taichung (TW)

(72) Inventor: Jian-Wei Lee, Taichung (TW)

(21) Appl. No.: 18/337,136

(22) Filed: Jun. 19, 2023

(30) Foreign Application Priority Data
Jul. 1, 2022 (TW) 111124783

(51) Int. Cl. G02B 13/06; G02B 13/00; G02B 9/64

(52) U.S. Cl. CPC G02B 13/06; G02B 13/0045; G02B 9/64

(57) ABSTRACT

A wide-angle lens assembly includes a first lens, a second lens, a third lens, a fourth lens, a fifth lens, a sixth lens, and a seventh lens. The first lens is with negative refractive power and includes a concave surface facing an object side. The second lens is a meniscus lens with refractive power. The third lens is a meniscus lens with positive refractive power. The fourth lens is with refractive power. The fifth lens is with refractive power. The sixth lens is with refractive power. The seventh lens is with positive refractive power. The first lens, the second lens, the third lens, the fourth lens, the fifth lens, the sixth lens, and the seventh lens are arranged in order from the object side to an image side along an optical axis.

### BACKGROUND OF THE INVENTION

### Field of the Invention

The present disclosure relates to a wide-angle lens assembly.

### Description of the Related Art

The current development trend of a wide-angle lens assembly is toward large field of view. Additionally, the wide-angle lens assembly is developed to have large aperture, and high resolution in accordance with different application requirements. However, the known wide-angle lens assembly can't satisfy such requirements. Therefore, the wide-angle lens assembly needs a new structure in order to meet the requirements of large field of view, large aperture, and high resolution at the same time.

### BRIEF SUMMARY OF THE INVENTION

The invention provides a wide-angle lens assembly to solve the above problems. The wide-angle lens assembly of the invention is provided with characteristics of an increased field of view, a small aperture value, an increased resolution, and still has a good optical performance.

The wide-angle lens assembly in accordance with an exemplary embodiment of the invention includes a first lens, a second lens, a third lens, a fourth lens, a fifth lens, a sixth lens, and a seventh lens. The first lens has negative refractive power and includes a concave surface facing an object side. The second lens is a meniscus lens with refractive power. The third lens is a meniscus lens with positive refractive power. The fourth lens has refractive power. The fifth lens has refractive power. The sixth lens has refractive power. The seventh lens has positive refractive power. The first lens, the second lens, the third lens, the fourth lens, the fifth lens, the sixth lens, and the seventh lens are arranged in order from the object side to an image side along an optical axis. When the wide-angle lens assembly of the present invention satisfies the above features and no other additional features or conditions are required, the basic functions of the wide-angle lens assembly of the present invention can be achieved.

In another exemplary embodiment, the second lens is with positive refractive power, the fifth lens is with positive refractive power, the sixth lens is with negative refractive power.

In yet another exemplary embodiment, the fifth lens is a biconvex lens and includes a convex surface facing the object side and another convex surface facing the image side, and the sixth lens is a biconcave lens and includes a concave surface facing the object side and another concave surface facing the image side.

In another exemplary embodiment, the fifth lens and the sixth lens are cemented.

In yet another exemplary embodiment, the wide-angle lens assembly satisfies at least one of the following conditions: 7.8≤TTL/HIH≤8.6; 5≤f3/f≤12; 1.8≤f7/f≤2.4; −4.5 mm≤(R21×R22)/(R21+R22)≤−2.8 mm; −10.1 mm≤(R31×R32)/(R31+R32)≤−4.8 mm; wherein TTL is an interval from the object side surface of the first lens to the image plane along the optical axis, HIH is a half image height of the wide-angle lens assembly, f3 is an effective focal length of the third lens, f7 is an effective focal length of the seventh lens, f is an effective focal length of the wide-angle assembly, R21 is a radius of curvature of an object side surface of the second lens, R22 is a radius of curvature of an image side surface of the second lens, R31 is a radius of curvature of an object side surface of the third lens, R32 is a radius of curvature of an image side surface of the third lens.

In another exemplary embodiment, the first lens further includes a concave surface facing the image side, and the second lens includes a concave surface facing the object side and a convex surface facing the image side.

In yet another exemplary embodiment, the third lens includes a concave surface facing the object side and a convex surface facing the image side, and the seventh lens is a biconvex lens and includes a convex surface facing the object side and another convex surface facing the image side.

In another exemplary embodiment, the fourth lens is with positive refractive power and includes a convex surface facing the image side.

In yet another exemplary embodiment, the fourth lens further includes a convex surface facing the object side.

In another exemplary embodiment, the fourth lens further includes a concave surface facing the object side.

In yet another exemplary embodiment, the wide-angle lens assembly further includes a stop disposed between the first lens and the second lens.

In another exemplary embodiment, the wide-angle lens assembly satisfies the following condition: 6.2≤L1D/DSL2≤10.5; wherein L1D is an outer diameter of the first lens and DSL2 is an air-interval from the stop to the object side surface of the second lens along the optical axes.

The above objects, features and advantages of the present disclosure will be more clearly understood from the following detailed description taken in conjunction with exemplary embodiments and the accompanying drawings.

### BRIEF DESCRIPTION OF THE DRAWINGS

FIG. 1 is a lens layout and optical path diagram of a wide-angle lens assembly in accordance with a second embodiment of the present disclosure;

FIG. 2, FIG. 3, and FIG. 4 depict a field curvature diagram, a distortion diagram, and a spot diagram of the wide-angle lens assembly in accordance with the second embodiment of the invention, respectively;

FIG. 5 is a lens layout and optical path diagram of a wide-angle lens assembly in accordance with a third embodiment of the present disclosure;

FIG. 6, FIG. 7, and FIG. 8 depict a field curvature diagram, a distortion diagram, and a spot diagram of the wide-angle lens assembly in accordance with the third embodiment of the invention, respectively;

FIG. 9 is a lens layout and optical path diagram of a wide-angle lens assembly in accordance with a fourth embodiment of the present disclosure;

FIG. 10, FIG. 11, and FIG. 12 depict a field curvature diagram, a distortion diagram, and a spot diagram of the wide-angle lens assembly in accordance with the fourth embodiment of the invention, respectively.

### DETAILED DESCRIPTION OF THE INVENTION

The following description is made for the purpose of illustrating the general principles of the invention and should not be taken in a limiting sense. The scope of the invention is best determined by reference to the appended claims.

The present invention provides a wide-angle lens assembly including a first lens, a second lens, a third lens, a fourth lens, a fifth lens, a sixth lens, and a seventh lens. The first lens having negative refractive power and includes a concave surface facing an object side. The second lens is a meniscus lens having refractive power. The third lens is a meniscus lens having positive refractive power. The fourth lens having refractive power. The fifth lens having refractive power. The sixth lens having refractive power. The seventh lens having positive refractive power. The first lens, the second lens, the third lens, the fourth lens, the fifth lens, the sixth lens, and the seventh lens are arranged in order from the object side to the image side along an optical axis. When the wide-angle lens of the present invention satisfies the above features and conditions, it is one of the preferred embodiments of the present invention.

Referring to Table 1, Table 2, Table 4, Table 5, Table 7, Table 8, Table 10, and Table 11, wherein Table 1, Table 4, Table 7 and Table 10 show optical specification in accordance with a first, second, third, and fourth embodiments of the invention, respectively and Table 2, Table 5, Table 8, and Table 11 show aspheric coefficients of each aspheric lens in Table 1, Table 4, Table 7, and Table 10, respectively. The aspheric surface sag z of each aspheric lens in the following embodiments can be calculated by the following formula: z ch²/{1+[1−(k+1)c²h²]^{1/2}}+Ah⁴+Bh⁶+Ch⁸±Dh¹⁰+Eh¹²±Fh¹⁴; where c is curvature, h is the vertical distance from the lens surface to the optical axis, k is conic constant, A, B, C, D, E, and F are aspheric coefficients, and the value of the aspheric coefficient A, B, C, D, E, and F are presented in scientific notation, such as 1.50E-03 for 1.50×10⁻³.

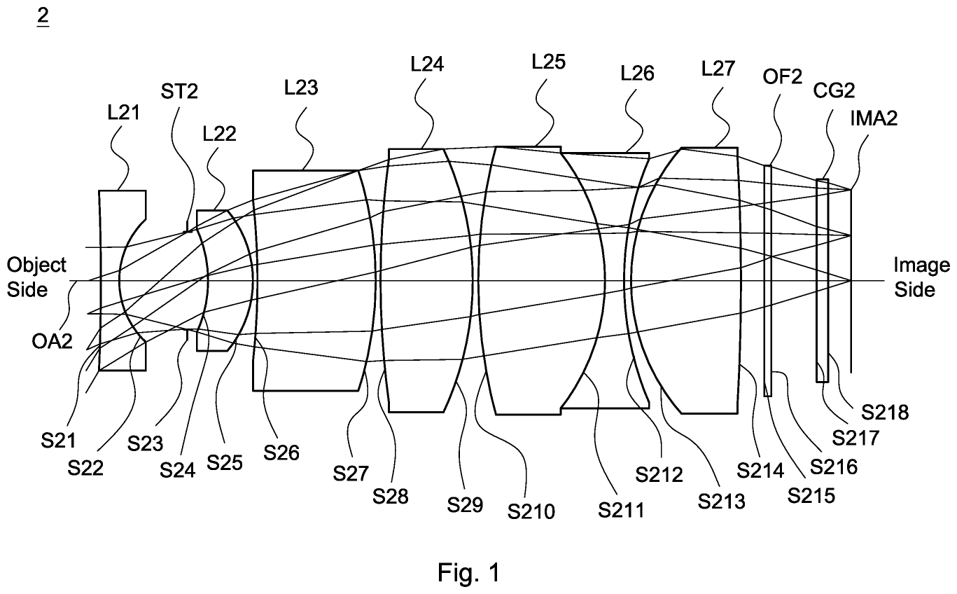

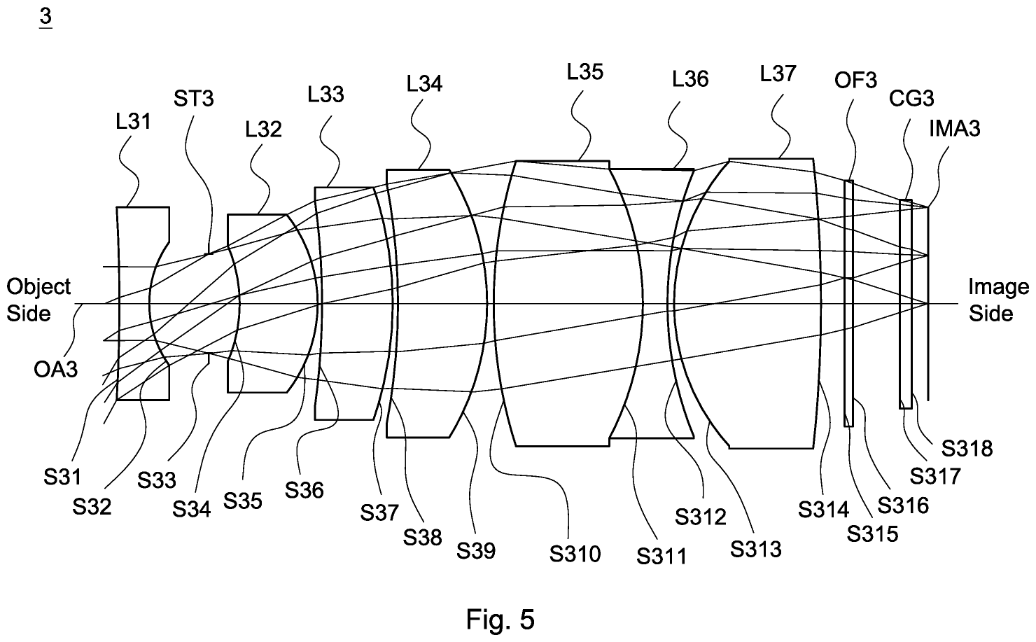

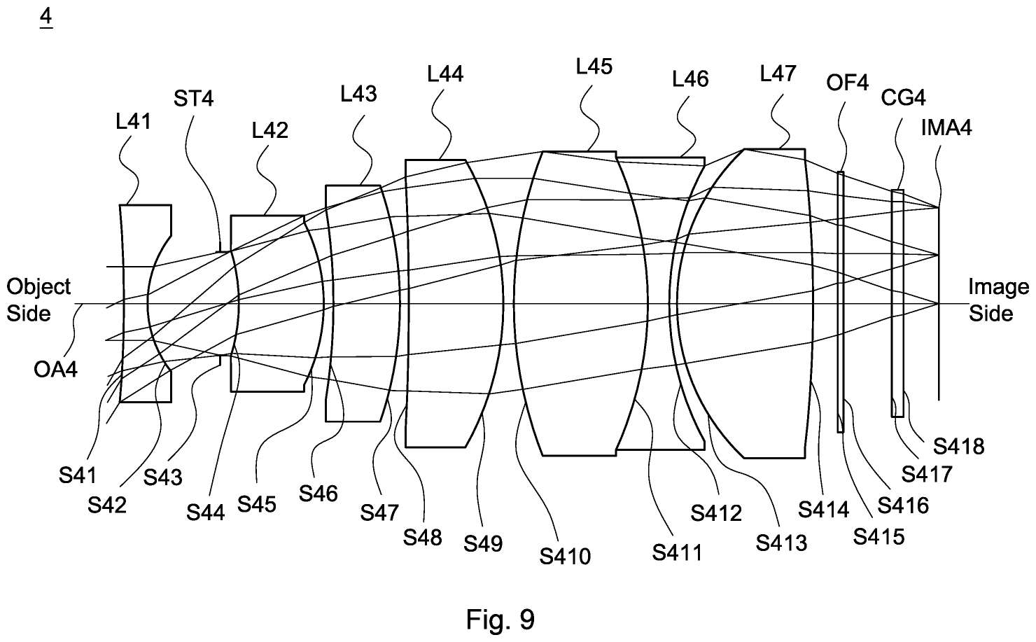

FIG. 1, FIG. 5, and FIG. 9 are lens layout and optical path diagrams of the wide-angle lens assemblies in accordance with the second, third, and fourth embodiments of the invention, respectively. The lens layout and optical path diagrams of a first embodiments approximate to that of the second embodiment, so that the illustration is omitted. However, the content of the first embodiments below, the element symbols are still being used for convenience of description.

The first lenses L11, L21, L31, L41 are biconcave lenses with negative refractive power and made of glass material, wherein the object side surfaces S11, S21, S31, S41 are concave surfaces, the image side surfaces S12, S22, S32, S42 are concave surfaces, and both of the object side surfaces S11, S21, S31, S41 and image side surfaces S12, S22, S32, S42 are spherical surfaces.

The second lenses L12, L22, L32, L42 are meniscus lens with positive refractive power and made of glass material, wherein the object side surfaces S14, S24, S34, S44 are concave surfaces, the image side surfaces S15, S25, S35, S45 are convex surfaces, and both of the object side surfaces S14, S24, S34, S44 and image side surfaces S15, S25, S35, S45 are aspheric surfaces.

The third lenses L13, L23, L33, L43 are meniscus lens with positive refractive power and made of glass material, wherein the object side surfaces S16, S26, S36, S46 are concave surfaces, the image side surfaces S17, S27, S37, S47 are convex surfaces, and both of the object side surfaces S16, S26, S36, S46 and image side surfaces S17, S27, S37, S47 are spherical surfaces.

The fourth lenses L14, L24, L34, L44 are with positive refractive power and made of glass material, wherein the object side surfaces S19, S29, S39, S49 are convex surfaces, and both of the object side surfaces S18, S28, S38, S48 and image side surfaces S19, S29, S39, S49 are spherical surfaces.

The fifth lenses L15, L25, L35, L45 are biconvex lens with positive refractive power and made of glass material, wherein the object side surfaces S110, S210, S310, S410 are convex surfaces, the image side surfaces S111, S211, S311, S411 are convex surfaces, and both of the object side surfaces S110, S210, S310, S410 and image side surfaces S111, S211, S311, S411 are spherical surfaces.

The sixth lenses L16, L26, L36, L46 are biconcave lens with negative refractive power and made of glass material, wherein the object side surfaces S111, S211, S311, S411 are concave surfaces, the image side surfaces S112, S212, S312, S412 are concave surfaces, and both of the object side surfaces S111, S211, S311, S411 and image side surfaces S112, S212, S312, S412 are spherical surfaces.

The seventh lenses L17, L27, L37, L47 are biconvex lens with positive refractive power and made of glass material, wherein the object side surfaces S113, S213, S313, S413 are convex surfaces, the image side surfaces S114, S214, S314, S414 are convex surfaces, and both of the object side surfaces S113, S213, S313, S413 and image side surfaces S114, S214, S314, S414 are spherical surfaces.

The fifth lenses L15, L25, L35, L45 are cemented with the sixth lenses L16, L26, L36, L46 respectively.

In addition, the wide-angle lens assemblies 1, 2, 3, and 4 satisfy at least one of the following conditions, it is a preferred embodiment of the invention:

7.8≤TTL/HIH≤8.6; (1)

5≤f3/f≤12; (2)

1.8≤f7/f≤2.4; (3)

−4.5 mm≤(R21×R22)/(R21+R22)≤−2.8 mm; (4)

−10.1 mm≤(R31×R32)/(R31+R32)≤−4.8 mm; (5)

6.2≤L1D/DSL2≤10.5; (6)

Wherein: TTL is an interval from the object side surfaces S11, S21, S31, S41 of the first lenses L11, L21, L31, L41 to the image plane IMA1, IMA2, IMA3, IMA4 along the optical axes OA1, OA2, OA3, OA4 for the first to fourth embodiments; HIH is a half image height of the wide-angle lens assemblies 1, 2, 3, 4 for the first to fourth embodiments; f3 is an effective focal length of the third lenses L13, L23, L33, L43 for the first to fourth embodiments; f7 is an effective focal length of the seventh lenses L17, L27, L37, L47 for the first to fourth embodiments; f is an effective focal length of the wide-angle lens assemblies 1, 2, 3, 4 for the first to fourth embodiments; R21 is a radius of curvature of the object side surfaces S14, S24, S34, S44 of the second lenses L12, L22, L32, L42 for the first to fourth embodiments; R22 is a radius of curvature of the image side surfaces S15, S25, S35, S45 of the second lenses L12, L22, L32, L42 for the first to fourth embodiments; R31 is a radius of curvature of the object side surfaces S16, S26, S36, S46 of the third lenses L13, L23, L33, L43 for the first to fourth embodiments; R32 is a radius of curvature of the image side surfaces S17, S27, S37, S47 of the third lenses L13, L23, L33, L43 for the first to fourth embodiments; L1D is an outer diameter of the first lenses L11, L21, L31, L41 for the first to fourth embodiments; DSL2 is a air-interval from the stops ST1, ST2, ST3, ST4 to the object side surfaces S14, S24, S34, S44 of the second lenses L12, L22, L32, L42 along the optical axes OA1, OA2, OA3, OA4 for the first to fourth embodiments. With the lens assemblies 1, 2, 3, 4 satisfying at least one of the above conditions (1)-(6), the field of view can be effectively increased, the resolution can be effectively increased, the aberration can be effectively corrected, and the chromatic aberration can be effectively corrected.

When the condition (1): 7.8≤TTL/HIH≤8.6 is satisfied, the total lens length can be effectively reduced.

When the condition (2): 5≤f3/f≤12 is satisfied, the effect of negative refractive power of the first lens can be effectively balanced.

When the condition (3): 1.8≤f7/f≤2.4 is satisfied, the chief ray angle can be effectively reduced.

When the condition (4): −4.5 mm≤(R21×R22)/(R21+R22)≤−2.8 mm is satisfied, the spherical aberration can be effectively reduced.

When the condition (5): −10.1 mm≤(R31×R32)/(R31+R32)≤−4.8 mm is satisfied, the field curvature can be effectively reduced.

When the condition (6): 6.2≤L1D/DSL2≤10.5 is satisfied, the outer diameter dimension of the first lens can be effectively controlled.

When the condition (4): −4.5 mm≤(R21×R22)/(R21+R22)≤−2.8 mm and the condition (5): −10.1 mm≤(R31×R32)/(R31+R32)≤−4.8 mm is satisfied, the aberration can be effectively reduced.

When the first lens is a biconcave lens with negative refractive power, the optical path can be effectively adjusted so that it is not easy to have a big turn.

When the second lens is a meniscus lens and an aspheric lens with positive refractive power, the chromatic aberration caused by the first lens being a biconcave lens can be effectively reduced to achieve the purpose of reducing the aberration.

When the object side surface of the third lens is concave surface and the image side surface is convex surface with positive refractive power, the total lens length can be effectively adjusted.

When the image side surface of the fourth lens is convex surface with positive refractive power, the total lens length can be effectively adjusted.

When the fifth lens and the sixth lens are cemented, the axial and lateral chromatic aberration can be effectively decreased and the resolution of wide-angle lens assembly can be effectively improved.

When the seventh lens is an aspheric lens with positive refractive power, the incident angle of chief ray can be reduced significantly and the back focal length can be effectively increased thereby facilitates the assembly of the wide-angle lens assembly.

A detailed description of a wide-angle lens assembly in accordance with a first embodiment of the invention is as follows. The wide-angle lens assembly 1 (not shown) includes a first lens L11, a stop ST1, a second lens L12, a third lens L13, a fourth lens L14, a fifth lens L15, a sixth lens L16, a seventh lens L17, an optical filter OF1, and a cover glass CG1, all of which are arranged in order from an object side to an image side along an optical axis OA1. In operation, the light from the object side is imaged on an image plane IMA1.

According to the foregoing, wherein: the fourth lens L14 is a biconvex lens, wherein the object side surface S18 is a convex surface; both of the object side surface S115 and image side surface S116 of the optical filter OF1 are plane surfaces; and both of the object side surface S117 and image side surface S118 of the cover glass CG1 are plane surfaces.

With the above design of the lenses, stop ST1, and at least one of the conditions (1)-(6) satisfied, the wide-angle lens assembly 1 (not shown) can have the field of view can be effectively increased, the resolution can be effectively increased, the aberration can be effectively corrected, and the chromatic aberration can be effectively corrected.

Table 1 shows the optical specification of the wide-angle lens assembly 1 (not shown).

TABLE 1
Effective Focal Length = 4.76 mm F-number = 1.60
Total Lens Length = 33.79 mm Field of View = 120.00 degrees

| | | | | | Effective | |
|---|---|---|---|---|---|---|
| | Radius of | | | | Focal | |
| Surface | Curvature | Thickness | | | Length | |
| Number | (mm) | (mm) | Nd | Vd | (mm) | Remark |
| S11 | −89.39 | 0.74 | 1.52 | 64.2 | −7.55 | The First Lens L11 |
| S12 | 4.11 | 3.18 | | | | |
| S13 | ∞ | 0.82 | | | | Stop ST1 |
| S14 | −9.04 | 1.97 | 1.51 | 64.1 | 22.64 | The Second Lens L12 |
| S15 | −5.47 | 0.23 | | | | |
| S16 | −10.24 | 5.05 | 1.9 | 31.32 | 54.49 | The Third Lens L13 |
| S17 | −10.48 | 0.26 | | | | |
| S18 | 31.52 | 4.96 | 1.5 | 81.61 | 19.28 | The Fourth Lens L14 |
| S19 | −13.10 | 0.14 | | | | |
| S110 | 21.08 | 6.02 | 1.83 | 37.16 | 8.87 | The Fifth Lens L15 |
| S111 | −10.00 | 0.77 | 1.92 | 20.88 | −5.72 | The Sixth Lens L16 |
| S112 | 11.86 | 0.27 | | | | |
| S113 | 8.02 | 4.92 | 1.65 | 58.11 | 10.89 | The Seventh Lens L17 |
| S114 | −46.80 | 1.00 | | | | |
| S115 | ∞ | 0.30 | 1.52 | 64.17 | | Optical Filter OF1 |
| S116 | ∞ | 2.00 | | | | |
| S117 | ∞ | 0.50 | 1.52 | 64.17 | | Cover Glass CG1 |
| S118 | ∞ | 0.66 | | | | |

In the first embodiment, the conic constant k and the aspheric coefficients A, B, C, D, E, F of each aspheric lens are shown in Table 2.

TABLE 2

| Surface | | | | | | | |
|---|---|---|---|---|---|---|---|
| Number | k | A | B | C | D | E | F |
| S14 | 0.379788 | −0.00251 | −0.00019 | 2.05E−05 | −4.6E−06 | 2.3E−07 | 0 |
| S15 | 0.077909 | −0.00095 | −5.8E−05 | −1.3E−06 | 6.94E−08 | −2.2E−08 | 0 |
| S113 | −0.38928 | −4.9E−05 | 2.51E−06 | −8.8E−08 | 2.06E−09 | −2.2E−11 | 0 |
| S114 | 22.36548 | 0.000267 | −2.1E−06 | 2.67E−08 | −1.6E−09 | 1.71E−11 | 0 |

Table 3 shows the parameters and condition values for conditions (1)-(6) in accordance with the first embodiment of the invention. It can be seen from Table 3 that the wide-angle lens assembly 1 of the first embodiment satisfies the conditions (1)-(6).

TABLE 3

| HIH | 4.03 mm | L1D | 8.03 mm | DSL2 | 0.82 mm |
|---|---|---|---|---|---|
| TTL/HIH | 8.38 | f3/f | 11.45 | f7/f | 2.29 |
| (R21 × R22)/ | | −3.41 mm | (R31 × R32)/ | | −5.18 mm |
| (R21 + R22) | | | (R31 + R32) | | |
| L1D/DSL2 | 9.80 | | | | |

A detailed description of a wide-angle lens assembly in accordance with a second embodiment of the invention is as follows. Referring to FIG. 1, the wide-angle lens assembly 2 includes a first lens L21, a stop ST2, a second lens L22, a third lens L23, a fourth lens L24, a fifth lens L25, a sixth lens L26, a seventh lens L27, an optical filter OF2, and a cover glass CG2, all of which are arranged in order from an object side to an image side along an optical axis OA2. In operation, an image of light rays from the object side is formed at an image plane IMA2.

According to the foregoing, wherein: the fourth lens L24 is a biconvex lens, wherein the object side surface S28 is a convex surface; both of the object side surface S215 and image side surface S216 of the optical filter OF2 are plane surfaces; and both of the object side surface S217 and image side surface S218 of the cover glass CG2 are plane surfaces.

With the above design of the lenses, stop ST2, and at least one of the conditions (1)-(6) satisfied, the wide-angle lens assembly 2 can have the field of view can be effectively increased, the resolution can be effectively increased, the aberration can be effectively corrected, and the chromatic aberration can be effectively corrected.

Table 4 shows the optical specification of the wide-angle lens assembly 2 in FIG. 1.

TABLE 4
Effective Focal Length = 4.77 mm F-number = 1.60
Total Lens Length = 33.30 mm Field of View = 120.00 degrees

| | | | | | Effective | |
|---|---|---|---|---|---|---|
| | Radius of | | | | Focal | |
| Surface | Curvature | Thickness | | | Length | |
| Number | (mm) | (mm) | Nd | Vd | (mm) | Remark |
| S21 | −85.26 | 0.82 | 1.52 | 64.2 | −7.18 | The First Lens L21 |
| S22 | 3.90 | 3.05 | | | | |
| S23 | ∞ | 0.88 | | | | Stop ST2 |
| S24 | −6.87 | 1.98 | 1.52 | 63.99 | 41.91 | The Second Lens L22 |
| S25 | −5.73 | 0.25 | | | | |
| S26 | −28.62 | 5.26 | 1.9 | 31.32 | 28.29 | The Third Lens L23 |
| S27 | −14.74 | 0.17 | | | | |
| S28 | 40.52 | 4.15 | 1.5 | 81.61 | 20.23 | The Fourth Lens L24 |
| S29 | −12.96 | 0.19 | | | | |
| S210 | 23.17 | 5.59 | 1.83 | 37.16 | 8.69 | The Fifth Lens L25 |
| S211 | −9.47 | 0.91 | 1.92 | 20.88 | −5.91 | The Sixth Lens L26 |
| S212 | 13.77 | 0.28 | | | | |
| S213 | 7.96 | 4.96 | 1.65 | 58.55 | 10.71 | The Seventh Lens L27 |
| S214 | −42.43 | 1.00 | | | | |
| S215 | ∞ | 0.30 | 1.52 | 64.17 | | Optical Filter OF2 |
| S216 | ∞ | 2.00 | | | | |
| S217 | ∞ | 0.50 | 1.52 | 64.17 | | Cover Glass CG2 |
| S218 | ∞ | 1.01 | | | | |

In the second embodiment, the conic constant k and the aspheric coefficients A, B, C, D, E, F of each aspheric lens are shown in Table 5.

TABLE 5

| Surface | | | | | | | |
|---|---|---|---|---|---|---|---|
| Number | k | A | B | C | D | E | F |
| S24 | −0.02294 | −0.00238 | −0.00018 | 2.12E−05 | −4.5E−06 | 2.39E−07 | 0 |
| S25 | 0.139781 | −0.00105 | −4.9E−05 | −7.1E−07 | 3.45E−08 | −1.5E−08 | 0 |
| S213 | −0.52587 | −9.1E−05 | 2.51E−06 | −6.4E−08 | 1.28E−09 | −1.4E−11 | 0 |
| S214 | 22.05268 | 0.000273 | −2.4E−06 | 1.39E−08 | −1E−09 | 1.3E−11 | 0 |

Table 6 shows the parameters and condition values for conditions (1)-(6) in accordance with the second embodiment of the invention. It can be seen from Table 6 that the wide-angle lens assembly 2 of the second embodiment satisfies the conditions (1)-(6).

TABLE 6

| HIH | 4.03 mm | L1D | 8.11 mm | DSL2 | 0.88 mm |
|---|---|---|---|---|---|
| TTL/HIH | 8.26 | f3/f | 5.93 | f7/f | 2.25 |
| (R21 × R22)/ | | −3.12 mm | (R31 × R32)/ | | −9.73 mm |
| (R21 + R22) | | | (R31 + R32) | | |
| L1D/DSL2 | 9.21 | | | | |

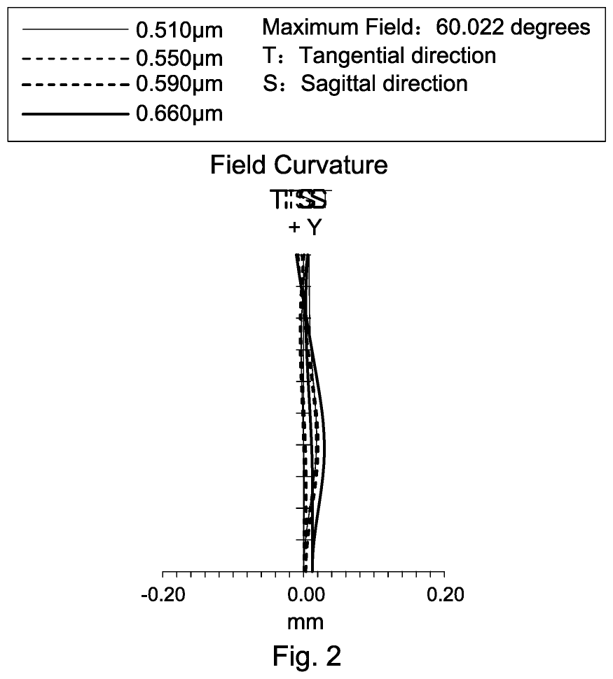

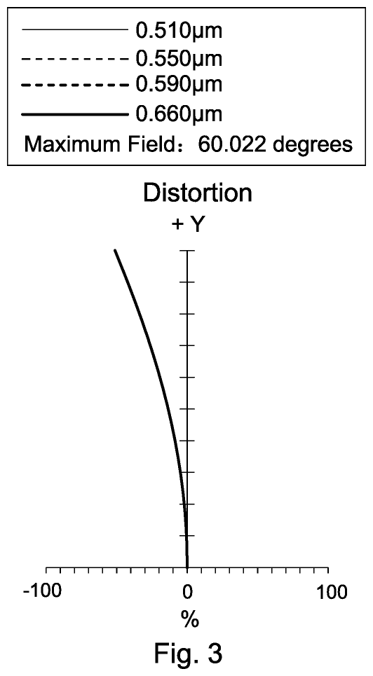

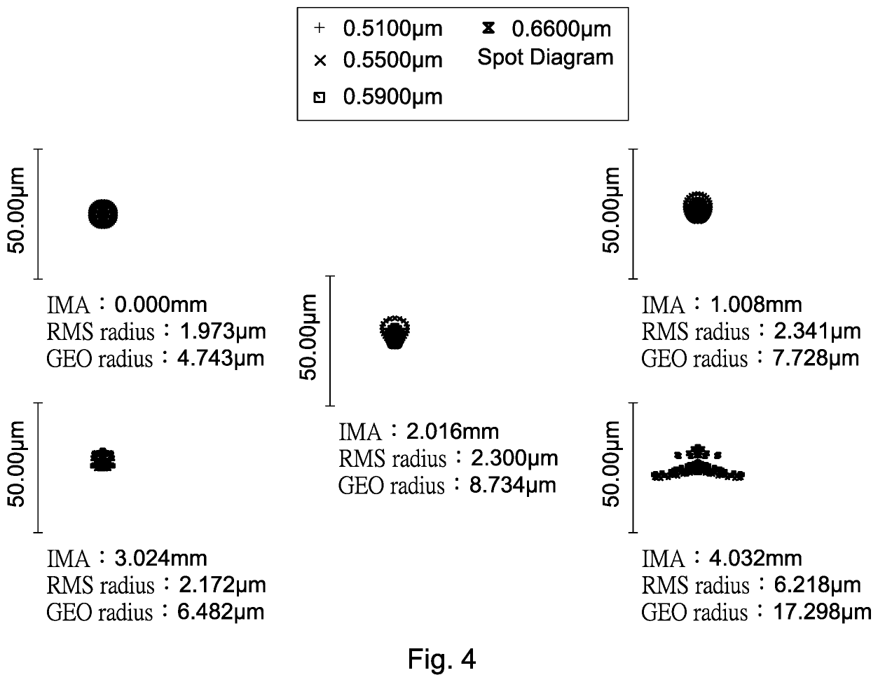

In addition, the wide-angle lens assembly 2 of the second embodiment can meet the requirements of optical performance as seen in FIGS. 2-4. It can be seen from FIG. 2 that the field curvature of tangential direction and sagittal direction in the wide-angle lens assembly 2 of the second embodiment ranges from −0.02 mm to 0.03 mm. It can be seen from FIG. 3 that the distortion in the wide-angle lens assembly 2 of the second embodiment ranges from −60% to 0%. It can be seen from FIG. 4 that the root mean square spot radius is equal to 1.973 um and geometrical spot radius is equal to 4.743 um as image height is equal to 0.000 mm, the root mean square spot radius is equal to 2.341 um and geometrical spot radius is equal to 7.728 um as image height is equal to 1.008 mm, the root mean square spot radius is equal to 2.300 um and geometrical spot radius is equal to 8.734 um as image height is equal to 2.016 mm, the root mean square spot radius is equal to 2.172 um and geometrical spot radius is equal to 6.482 um as image height is equal to 3.024 mm, and the root mean square spot radius is equal to 6.218 um and geometrical spot radius is equal to 17.298 um as image height is equal to 4.032 mm for the wide-angle lens assembly 2 of the second embodiment.

It is obvious that the field curvature and the distortion of the wide-angle lens assembly 2 of the second embodiment can be corrected effectively. Therefore, the wide-angle lens assembly 2 of the second embodiment is capable of good optical performance.

A detailed description of a wide-angle lens assembly in accordance with a third embodiment of the invention is as follows. Referring to FIG. 5, the wide-angle lens assembly 3 includes a first lens L31, a stop ST3, a second lens L32, a third lens L33, a fourth lens L34, a fifth lens L35, a sixth lens L36, a seventh lens L37, an optical filter OF3, and a cover glass CG3, all of which are arranged in order from an object side to an image side along an optical axis OA3. In operation, an image of light rays from the object side is formed at an image plane IMA3.

According to the foregoing, wherein: the fourth lens L34 is a meniscus lens, wherein the object side surface S38 is a concave surface; both of the object side surface S315 and image side surface S316 of the optical filter OF3 are plane surfaces; and both of the object side surface S317 and image side surface S318 of the cover glass CG3 are plane surfaces.

With the above design of the lenses, stop ST3, and at least one of the conditions (1)-(6) satisfied, the wide-angle lens assembly 3 can have the field of view can be effectively increased, the resolution can be effectively increased, the aberration can be effectively corrected, and the chromatic aberration can be effectively corrected.

Table 7 shows the optical specification of the wide-angle lens assembly 3 in FIG. 5.

TABLE 7
Effective Focal Length = 4.94 mm F-number = 1.60
Total Lens Length = 35.86 mm Field of View = 120.00 degrees

| | | | | | Effective | |
|---|---|---|---|---|---|---|
| | Radius of | | | | Focal | |
| Surface | Curvature | Thickness | | | Length | |
| Number | (mm) | (mm) | Nd | Vd | (mm) | Remark |
| S31 | −55.34 | 1.16 | 1.52 | 64.2 | −7.68 | The First Lens L31 |
| S32 | 4.32 | 2.55 | | | | |
| S33 | ∞ | 1.28 | | | | Stop ST3 |
| S34 | −8.35 | 3.25 | 1.52 | 63.99 | 38.83 | The Second Lens L32 |
| S35 | −6.67 | 0.25 | | | | |
| S36 | −27.90 | 2.94 | 1.9 | 31.32 | 28.64 | The Third Lens L33 |
| S37 | −14.15 | 0.20 | | | | |
| S38 | −27.44 | 3.82 | 1.5 | 81.61 | 30.41 | The Fourth Lens L34 |
| S39 | −10.21 | 0.19 | | | | |
| S310 | 18.54 | 6.34 | 1.8 | 46.57 | 9.76 | The Fifth Lens L35 |
| S311 | −11.61 | 0.98 | 1.92 | 20.88 | −6.91 | The Sixth Lens L36 |
| S312 | 15.05 | 0.27 | | | | |
| S313 | 8.00 | 6.19 | 1.65 | 58.55 | 10.88 | The Seventh Lens L37 |
| S314 | −43.14 | 3.00 | | | | |
| S315 | ∞ | 0.30 | 1.52 | 64.17 | | Optical Filter OF3 |
| S316 | ∞ | 2.00 | | | | |
| S317 | ∞ | 0.50 | 1.52 | 64.17 | | Cover Glass CG3 |
| S318 | ∞ | 0.64 | | | | |

In the third embodiment, the conic constant k and the aspheric coefficients A, B, C, D, E, F of each aspheric lens are shown in Table 8.

TABLE 8

| Surface | | | | | | | |
|---|---|---|---|---|---|---|---|
| Number | k | A | B | C | D | E | F |
| S34 | −0.25172 | −0.00217 | −4.7E−05 | −1.5E−05 | 2.89E−06 | −3.9E−07 | 1.87E−08 |
| S35 | −0.37859 | −0.0008 | −1.9E−05 | 8.47E−08 | −6.4E−08 | 2.8E−09 | −9.7E−11 |
| S313 | −0.54252 | −0.00011 | 1.27E−06 | −6.4E−09 | −8.1E−10 | 2.56E−11 | −3.3E−13 |
| S314 | 7.631504 | 0.000163 | −4E−06 | 3.66E−08 | −7E−10 | 2.13E−12 | 6.86E−15 |

Table 9 shows the parameters and condition values for conditions (1)-(6) in accordance with the third embodiment of the invention. It can be seen from Table 9 that the wide-angle lens assembly 3 of the third embodiment satisfies the conditions (1)-(6).

TABLE 9

| HIH | 4.03 mm | L1D | 8.20 mm | DSL2 | 1.28 mm |
|---|---|---|---|---|---|
| TTL/HIH | 8.89 | f3/f | 5.80 | f7/f | 2.20 |
| (R21 × R22)/ | | −3.71 mm | (R31 × R32)/ | | −9.39 mm |
| (R21 + R22) | | | (R31 + R32) | | |
| L1D/DSL2 | 6.40 | | | | |

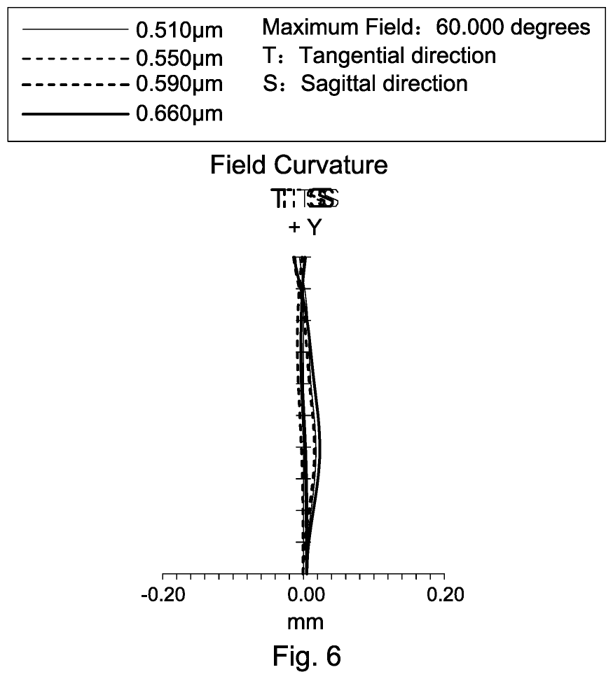

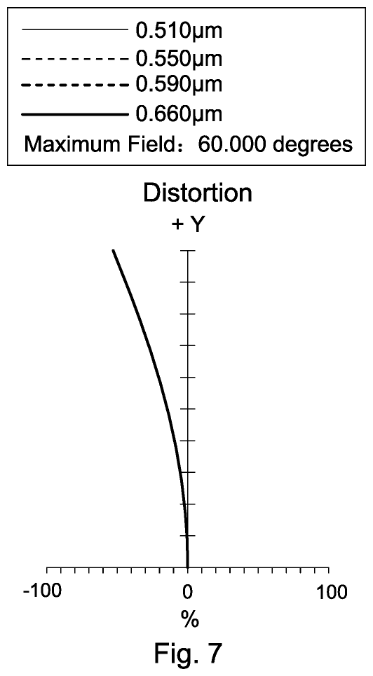

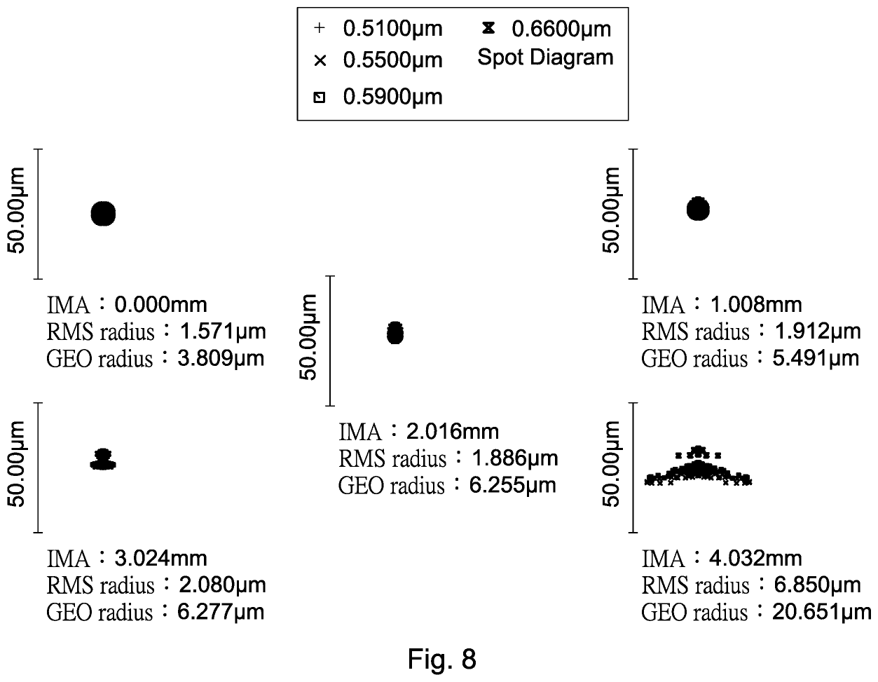

In addition, the wide-angle lens assembly 3 of the third embodiment can meet the requirements of optical performance as seen in FIGS. 6-8. It can be seen from FIG. 6 that the field curvature of tangential direction and sagittal direction in the wide-angle lens assembly 3 of the third embodiment ranges from −0.02 mm to 0.03 mm. It can be seen from FIG. 7 that the distortion in the wide-angle lens assembly 3 of the third embodiment ranges from −60% to 0%. It can be seen from FIG. 8 that the root mean square spot radius is equal to 1.571 um and geometrical spot radius is equal to 3.809 um as image height is equal to 0.000 mm, the root mean square spot radius is equal to 1.912 um and geometrical spot radius is equal to 5.491 um as image height is equal to 1.008 mm, the root mean square spot radius is equal to 1.886 um and geometrical spot radius is equal to 6.255 um as image height is equal to 2.016 mm, the root mean square spot radius is equal to 2.080 um and geometrical spot radius is equal to 6.277 um as image height is equal to 3.024 mm, and the root mean square spot radius is equal to 6.850 um and geometrical spot radius is equal to 20.651 um as image height is equal to 4.032 mm for the wide-angle lens assembly 3 of the third embodiment.

It is obvious that the field curvature and the distortion of the wide-angle lens assembly 3 of the third embodiment can be corrected effectively. Therefore, the wide-angle lens assembly 3 of the third embodiment is capable of good optical performance.

A detailed description of a wide-angle lens assembly in accordance with a fourth embodiment of the invention is as follows. Referring to FIG. 9, the wide-angle lens assembly 4 includes a first lens L41, a stop ST4, a second lens L42, a third lens L43, a fourth lens L44, a fifth lens L45, a sixth lens L46, a seventh lens L47, an optical filter OF4, and a cover glass CG4, all of which are arranged in order from an object side to an image side along an optical axis OA4. In operation, an image of light rays from the object side is formed at an image plane IMA4.

According to the foregoing, wherein: the fourth lens L44 is a meniscus lens, wherein the object side surface S48 is a concave surface; both of the object side surface S415 and image side surface S416 of the optical filter OF4 are plane surfaces; and both of the object side surface S417 and image side surface S418 of the cover glass CG4 are plane surfaces.

With the above design of the lenses, stop ST4, and at least one of the conditions (1)-(6) satisfied, the wide-angle lens assembly 4 can have the field of view can be effectively increased, the resolution can be effectively increased, the aberration can be effectively corrected, and the chromatic aberration can be effectively corrected.

Table 10 shows the optical specification of the wide-angle lens assembly 4 in FIG. 9.

TABLE 10
Effective Focal Length = 4.95 mm F-number = 1.60
Total Lens Length = 35.93 mm Field of View = 119.96 degrees

| | | | | | Effective | |
|---|---|---|---|---|---|---|
| | Radius of | | | | Focal | |
| Surface | Curvature | Thickness | | | Length | |
| Number | (mm) | (mm) | Nd | Vd | (mm) | Remark |
| S41 | −51.96 | 0.96 | 1.52 | 64.2 | −8.19 | The First Lens L41 |
| S42 | 4.65 | 3.05 | | | | |
| S43 | ∞ | 0.80 | | | | Stop ST4 |
| S44 | −8.46 | 3.55 | 1.52 | 63.99 | 236.68 | The Second Lens L42 |
| S45 | −9.04 | 0.32 | | | | |
| S46 | −29.96 | 2.86 | 1.9 | 31.32 | 27.94 | The Third Lens L43 |
| S47 | −14.38 | 0.26 | | | | |
| S48 | −236.54 | 4.02 | 1.5 | 81.61 | 25.82 | The Fourth Lens L44 |
| S49 | −12.27 | 0.43 | | | | |
| S410 | 16.79 | 5.56 | 1.8 | 46.57 | 10.61 | The Fifth Lens L45 |
| S411 | −14.91 | 0.96 | 1.92 | 20.88 | −7.21 | The Sixth Lens L46 |
| S412 | 12.62 | 0.28 | | | | |
| S413 | 7.64 | 5.67 | 1.65 | 58.55 | 10.18 | The Seventh Lens L47 |
| S414 | −35.67 | 3.00 | | | | |
| S415 | ∞ | 0.30 | 1.52 | 64.17 | | Optical Filter OF4 |
| S416 | ∞ | 2.00 | | | | |
| S417 | ∞ | 0.50 | 1.52 | 64.17 | | Cover Glass CG4 |
| S418 | ∞ | 1.41 | | | | |

In the fourth embodiment, the conic constant k and the aspheric coefficients A, B, C, D, E, F of each aspheric lens are shown in Table 11.

TABLE 11

| Surface | | | | | | | |
|---|---|---|---|---|---|---|---|
| Number | k | A | B | C | D | E | F |
| S44 | −3.4537 | −0.00232 | −4.9E−05 | −3.1E−06 | 2.78E−06 | −7.1E−07 | 5.51E−08 |
| S45 | −0.44663 | −0.00069 | −1E−06 | −8.5E−07 | 6.31E−08 | −3.1E−09 | 5.88E−11 |
| S413 | −0.59968 | −9.1E−05 | 6.56E−07 | 2.49E−08 | −1.1E−09 | 2.33E−11 | −2.4E−13 |
| S414 | 2.187154 | 0.000241 | −3.6E−06 | 6.58E−08 | −1.4E−09 | 9.31E−12 | −1.1E−14 |

Table 12 shows the parameters and condition values for conditions (1)-(6) in accordance with the fourth embodiment of the invention. It can be seen from Table 12 that the wide-angle lens assembly 4 of the fourth embodiment satisfies the conditions (1)-(6).

TABLE 12

| HIH | 4.03 mm | L1D | 8.26 mm | DSL2 | 0.80 mm |
|---|---|---|---|---|---|
| TTL/HIH | 8.91 | f3/f | 5.64 | f7/f | 2.06 |
| (R21 × R22)/ | | −4.37 mm | (R31 × R32)/ | | −9.72 mm |
| (R21 + R22) | | | (R31 + R32) | | |
| L1D/DSL2 | 10.32 | | | | |

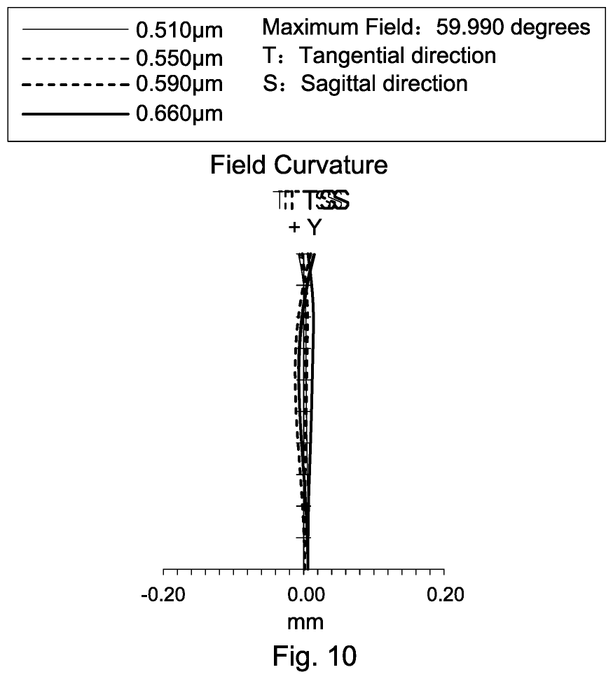

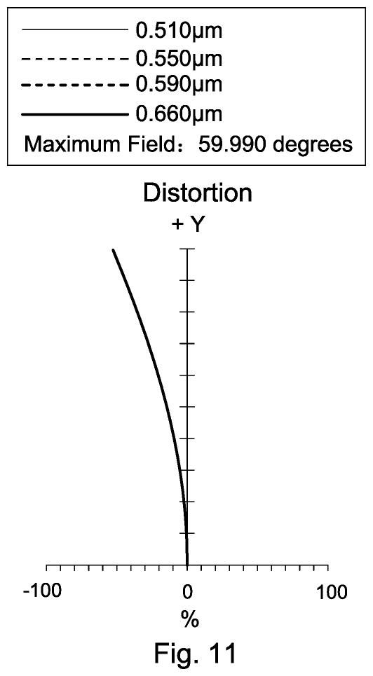

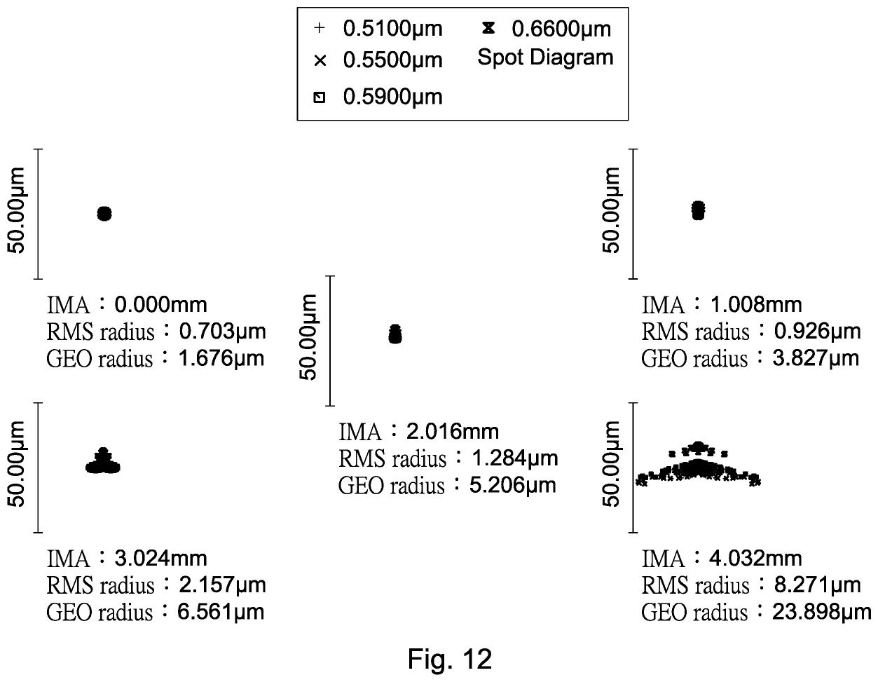

In addition, the wide-angle lens assembly 4 of the fourth embodiment can meet the requirements of optical performance as seen in FIGS. 10-12. It can be seen from FIG. 11 that the field curvature of tangential direction and sagittal direction in the wide-angle lens assembly 4 of the fourth embodiment ranges from −0.02 mm to 0.02 mm. It can be seen from FIG. 11 that the distortion in the wide-angle lens assembly 4 of the fourth embodiment ranges from −60% to 0%. It can be seen from FIG. 12 that the root mean square spot radius is equal to 0.703 um and geometrical spot radius is equal to 1.676 um as image height is equal to 0.000 mm, the root mean square spot radius is equal to 0.926 um and geometrical spot radius is equal to 3.827 um as image height is equal to 1.008 mm, the root mean square spot radius is equal to 1.284 um and geometrical spot radius is equal to 5.206 um as image height is equal to 2.016 mm, the root mean square spot radius is equal to 2.157 um and geometrical spot radius is equal to 6.561 um as image height is equal to 3.024 mm, and the root mean square spot radius is equal to 8.271 um and geometrical spot radius is equal to 23.898 um as image height is equal to 4.032 mm for the wide-angle lens assembly 4 of the fourth embodiment.

It is obvious that the field curvature and the distortion of the wide-angle lens assembly 4 of the third embodiment can be corrected effectively. Therefore, the wide-angle lens assembly 4 of the fourth embodiment is capable of good optical performance.

It should be understood that although the present disclosure has been described with reference to the above preferred embodiments, these embodiments are not intended to retrain the present disclosure. It will be apparent to one of ordinary skill in the art that various changes or modifications to the described embodiments can be made without departing from the spirit of the present disclosure. Accordingly, the scope of the present disclosure is defined by the attached claims.

What is claimed is:

1. A wide-angle lens assembly comprising:
a first lens with negative refractive power, which includes a concave surface facing an object side;
a second lens which is a meniscus lens with refractive power;
a third lens which is a meniscus lens with positive refractive power;
a fourth lens with refractive power;
a fifth lens with refractive power;
a sixth lens with refractive power; and
a seventh lens with positive refractive power;
wherein the first lens, the second lens, the third lens, the fourth lens, the fifth lens, the sixth lens, and the seventh lens are arranged in order from the object side to an image side along an optical axis.

2. The wide-angle lens assembly as claimed in claim 1, wherein:
the second lens is with positive refractive power;
the fifth lens is with positive refractive power; and
the sixth lens is with negative refractive power.

3. The wide-angle lens assembly as claimed in claim 2, wherein:
the fifth lens is a biconvex lens and comprises a convex surface facing the object side and another convex surface facing the image side; and
the sixth lens is a biconcave lens and comprises a concave surface facing the object side and another concave surface facing the image side.

4. The wide-angle lens assembly as claimed in claim 3, wherein the fifth lens and the sixth lens are cemented.

5. The wide-angle lens assembly as claimed in claim 4, wherein the wide-angle lens assembly satisfies at least one of the following conditions:
7.8≤TTL/HIH≤8.6;
5≤f3/f≤12;
1.8≤f7/f≤2.4;
−4.5 mm≤(R21×R22)/(R21+R22)≤−2.8 mm;
−10.1 mm≤(R31×R32)/(R31+R32)≤−4.8 mm;
wherein TTL is an interval from the object side surface of the first lens to the image plane along the optical axis, HIH is a half image height of the wide-angle lens assembly, f3 is an effective focal length of the third lens, f7 is an effective focal length of the seventh lens, f is an effective focal length of the wide-angle assembly, R21 is a radius of curvature of an object side surface of the second lens, R22 is a radius of curvature of an image side surface of the second lens, R31 is a radius of curvature of an object side surface of the third lens, R32 is a radius of curvature of an image side surface of the third lens.

6. The wide-angle lens assembly as claimed in claim 1, wherein:
the first lens further comprises a concave surface facing the image side; and
the second lens comprises a concave surface facing the object side and a convex surface facing the image side.

7. The wide-angle lens assembly as claimed in claim 6, wherein the wide-angle lens assembly satisfies at least one of the following conditions:
7.8≤TTL/HIH≤8.6;
5≤f3/f≤12;
1.8≤f7/f≤2.4;
−4.5 mm≤(R21×R22)/(R21+R22)≤−2.8 mm;
−10.1 mm≤(R31×R32)/(R31+R32)≤−4.8 mm;
wherein TTL is an interval from the object side surface of the first lens to the image plane along the optical axis, HIH is a half image height of the wide-angle lens assembly, f3 is an effective focal length of the third lens, f7 is an effective focal length of the seventh lens, f is an effective focal length of the wide-angle assembly, R21 is a radius of curvature of an object side surface of the second lens, R22 is a radius of curvature of an image side surface of the second lens, R31 is a radius of curvature of an object side surface of the third lens, R32 is a radius of curvature of an image side surface of the third lens.

8. The wide-angle lens assembly as claimed in claim 1, wherein:
the third lens comprises a concave surface facing the object side and a convex surface facing the image side; and
the seventh lens is a biconvex lens and comprises a convex surface facing the object side and another convex surface facing the image side.

9. The wide-angle lens assembly as claimed in claim 8, wherein the wide-angle lens assembly satisfies at least one of the following conditions:
7.8≤TTL/HIH≤8.6;
5≤f3/f≤12;
1.8≤f7/f≤2.4;
−4.5 mm≤(R21×R22)/(R21+R22)≤−2.8 mm;
−10.1 mm≤(R31×R32)/(R31+R32)≤−4.8 mm;
wherein TTL is an interval from the object side surface of the first lens to the image plane along the optical axis, HIH is a half image height of the wide-angle lens assembly, f3 is an effective focal length of the third lens, f7 is an effective focal length of the seventh lens, f is an effective focal length of the wide-angle assembly, R21 is a radius of curvature of an object side surface of the second lens, R22 is a radius of curvature of an image side surface of the second lens, R31 is a radius of curvature of an object side surface of the third lens, R32 is a radius of curvature of an image side surface of the third lens.

10. The wide-angle lens assembly as claimed in claim 1, wherein the fourth lens is with positive refractive power and comprises a convex surface facing the image side.

11. The wide-angle lens assembly as claimed in claim 10, wherein the fourth lens further comprises a convex surface facing the object side.

12. The wide-angle lens assembly as claimed in claim 11, wherein the wide-angle lens assembly satisfies at least one of the following conditions:
7.8≤TTL/HIH≤8.6;
5≤f3/f≤12;
1.8≤f7/f≤2.4;
−4.5 mm≤(R21×R22)/(R21+R22)≤−2.8 mm;
−10.1 mm≤(R31×R32)/(R31+R32)≤−4.8 mm;
wherein TTL is an interval from the object side surface of the first lens to the image plane along the optical axis, HIH is a half image height of the wide-angle lens assembly, f3 is an effective focal length of the third lens, f7 is an effective focal length of the seventh lens, f is an effective focal length of the wide-angle assembly, R21 is a radius of curvature of an object side surface of the second lens, R22 is a radius of curvature of an image side surface of the second lens, R31 is a radius of curvature of an object side surface of the third lens, R32 is a radius of curvature of an image side surface of the third lens.

13. The wide-angle lens assembly as claimed in claim 10, wherein the fourth lens further comprises a concave surface facing the object side.

14. The wide-angle lens assembly as claimed in claim 13, wherein the wide-angle lens assembly satisfies at least one of the following conditions:
7.8≤TTL/HIH≤8.6;
5≤f3/f≤12;
1.8≤f7/f≤2.4;
−4.5 mm≤(R21×R22)/(R21+R22)≤−2.8 mm;
−10.1 mm≤(R31×R32)/(R31+R32)≤−4.8 mm;
wherein TTL is an interval from the object side surface of the first lens to the image plane along the optical axis, HIH is a half image height of the wide-angle lens assembly, f3 is an effective focal length of the third lens, f7 is an effective focal length of the seventh lens, f is an effective focal length of the wide-angle assembly, R21 is a radius of curvature of an object side surface of the second lens, R22 is a radius of curvature of an image side surface of the second lens, R31 is a radius of curvature of an object side surface of the third lens, R32 is a radius of curvature of an image side surface of the third lens.

15. The wide-angle lens assembly as claimed in claim 1, further comprising a stop disposed between the first lens and the second lens.

16. The wide-angle lens assembly as claimed in claim 15, wherein the wide-angle lens assembly satisfies the following condition:
6.2≤L1D/DSL2≤10.5;
wherein L1D is an outer diameter of the first lens and DSL2 is an air-interval from the stop to the object side surface of the second lens along the optical axes.

17. The wide-angle lens assembly as claimed in claim 16, wherein the wide-angle lens assembly satisfies at least one of the following conditions:
7.8≤TTL/HIH≤8.6;
5≤f3/f≤12;
1.8≤f7/f≤2.4;
−4.5 mm≤(R21×R22)/(R21+R22)≤−2.8 mm;
−10.1 mm≤(R31×R32)/(R31+R32)≤−4.8 mm;
wherein TTL is an interval from the object side surface of the first lens to the image plane along the optical axis, HIH is a half image height of the wide-angle lens assembly, f3 is an effective focal length of the third lens, f7 is an effective focal length of the seventh lens, f is an effective focal length of the wide-angle assembly, R21 is a radius of curvature of an object side surface of the second lens, R22 is a radius of curvature of an image side surface of the second lens, R31 is a radius of curvature of an object side surface of the third lens, R32 is a radius of curvature of an image side surface of the third lens.
